(19) United States
(12) Patent Application Publication
(10) Pub. No.: US 2005/0193605 A1
(43) Pub. Date: Sep. 8, 2005

(54) Solar/electric powered multi-layered signs using LED lamps and/or fibre optic light sources to enhance readability

(76) Inventor: William Ahmadi, Los Angeles, CA (US)

Correspondence Address: WILLIAM AHMADI, P.O. Box 70328, Los Angeles, CA, 90070, US

(21) Appl. No.: 11/067,057

(22) Filed: Feb. 28, 2005

Related U.S. Application Data
(60) Provisional application No. 60/547,551, filed on Feb. 26, 2004.

(51) Int. Cl. G09F 13/28

(52) U.S. Cl. 40/550; 40/551

(57) ABSTRACT

A system and device to enhance the visibility of signs by using ambient or projected light, Solar or Electric powered LED's or Fiber Optic Lights to enhance the sign legend.

This application claims priority from Provisional Application No. 60/547,551 Filed on Feb. 26, 2004

### FIELD OF INVENTION

This invention relates to a solar or mains powered multi-layered sign using LED Lamps and/or Fiber Optic Devices, included is a mirrored back plate to enhance the light source and provide maximum readability in low light conditions.

### BACKGROUND OF THE INVENTION

There are many types of complex and simple signs. Signs may be attached to interior or exterior wall of buildings, or suspended from overhead supports or supported by purpose built structures. Signs may or may not be powered by external means. Signs are used for example for: advertising, street direction signs, or to identify a building, room or a service, such signs are made and used in great numbers because they are of simple construction and, therefore generally inexpensive to construct and maintain.

On the inside of buildings, simple signs are usually easy to read because they are illuminated or capable of being illuminated by unattached nearby light fixtures or internal lamps.

Often, simple signs on the outside of buildings are not illuminated and become difficult or impossible to read in poor light conditions or when it gets dark. In many cases one would not know that a sign is present in a given location if it is not illuminated. Yet, if one could read the message on the sign, it would be of great assistance when looking for directional information or a street address. Thus the is a need for a comparatively simple, inexpensive sign capable of being illuminated by means of low powered, low cost light sources having low maintenance needs. The signs can be used in locations that have mains electric services or in places that do not have such services or where it would be too expensive to provide mains electric services. By the use of LED Lamp Technology and/or Fiber Optic Devices the readability of signs will be vastly improved. Solar Technology and Energy Storage Devices can be used as an alternative electric power source.

### BRIEF SUMMARY OF THE INVENTION

To overcome some of the disadvantages referred to above, applicant has devised a low cost improved sign that is illuminated but which utilizes Light Emitting Diodes and/or Fiber Optic Lighting Devices to provide illumination for a sign that has enhanced readability in low light conditions, the present invention utilizes a stacked assembly consisting of:
1) a bottom layer having a shiny, reflecting surface which could be a mirror, coated glass, metal or plastic sheet or coated film, any of which has a surface capable of reflecting light;
2) A layer of prismatic material such a clear plastic with a regular or irregular pattern, molded, cast, embossed or etched on the surface;
3) A faceplate having a message which is transparent or cut out to expose the prismatic layer and an opaque background or vice versa, and
4) a protective layer of transparent material which could be film, glass or clear plastic such as Lexan, this layer is preferably manufactured or coated with an ultraviolet protective material and/o an abrasion resistant material and/or a graffiti resistant material or a combination of any of these protection qualities.

A combination of the above layers in placement order other than described above can also produce enhanced readability of signs.

It has been found that a layer of prismatic plastic material having a regular or irregular surfaced is effective to gather and reflect light. By placing a faceplate containing a message over the prismatic layer with the message either transparent with an opaque background or vice versa, light is enhanced and reflected back through the transparent layer while contrasting with the opaque background or surrounding material.

A chamber is formed by using spacers between layer 1 and layer 2 to keep the layers apart, this space is used to introduce LED or Fiber Optic Light into the chamber either through the sides of the chamber or directly by LED Lights or Fiber Optic Light introduced through holes in Layer I. The placement of the light source may be in regular or irregular pattern of may be in the shape of alpha-numeric character or a logo design.

The second layer described above is preferably of a clear plastic material having a regular or irregular surface which has numerous angles and elevations. One successful plastic material has a totally random irregular surface. The second layer above described may have one side coated to enhance its reflective qualities; this would obviate the need for the first layer described above.

The third layer consists of a layer of plastic film that is secured to the surface of the second layer, the third layer could also be of paper or other material rigid or flexible material having opaque and transparent areas formed but removing areas of the plate to form messages.

The area between Layer 1 and Layer 2 is used to insert LED or Fiber Optic light into the sign.

A sign formed of the above described layers, illuminated and stacked as described remains legible in low light conditions.

The sign may be of any shape, regular or irregular on the periphery and may be convex or concave or in any moldable or formed shape on the sign face plane.

Different colored layers may be used to enhance the visual effect.

The plates may be laminated or joined together using glue, plastic coatings, Radio Frequency Welding, Solvents or using nuts, bolts or screws. The edges may be held together by inserting the plates into molded or extruded members made of rubber, plastic, metal or any other material that is moldable or extruded or formed to hold the plate together with or without air gaps between the plates

### DESCRIPTION OF DRAWINGS

This invention may be more clearly understood with the following detailed description and by reference to the drawings in which the stacked plates are as follows:

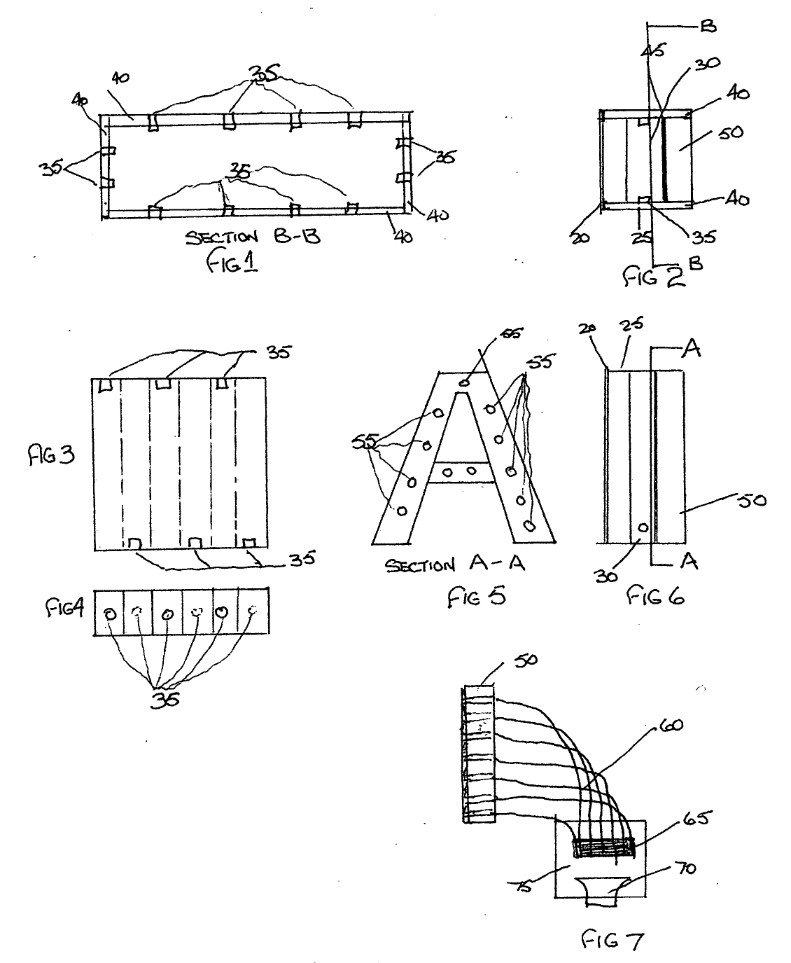

FIG. 1
35 Shows Light Emitting Diodes Placed in Panel 40
40 Side Plate for protecting LED Devices, Fiber Optic Lights and Electric Wiring for such devices, Fiber Optic Cables may be inserted at 35 instead of, or together with LEDs

FIG. 2,
45 Prismatic plate coated on smooth side to reflect light provided by LED 35 back through Protective plate 40. the prismatic side of this plate enhances the light traveling through the plate to the Legend Film Coating where it is viewable.
20. Protective Film laminated to 25
25 Legend Plate used to carry the message to be displayed by the sign
30 Space to Insert light source
40 Protective Side Plate
50 Shiny one side Protection Plate used to reflect light, strengthen and keep sign readable.

FIG. 3
Is a view of alternative plate to be placed in space 30 shown in FIG. 2, this material is manufactured under the trade name Polygal Sheet
35 Position of Led Devices or Fiber Optic light sources

FIG. 4
Top view of plate shown in FIG. 3 showing position of LED Lights or Fiber Optic Devices used to illuminate the channels in Polygal Sheet

FIG. 5
Is an example of different shapes that may be used on the outside profile of the sign showing positions of LEDs marked 55 in section through A-A
The stacked laminated layers are as generally describe in FIG. 1

FIG. 7
Shows view through FIG. 6 Section A-A and shows general method of using Fiber Optic Fibers and LED Light Source
50 Plate described in FIG. 2
60 Fiber Optic Fibers for transmitting light collected from LRD Light Source marked 70
65 Bush to hold Fibers together
70 LED Light Source
75 Outer Casing to hold light source 70 and Fibers 65 in position to gather light into 65.

Operation

The sign is operated by light gathered from a light source 35 being enhanced and reflected from a mirrored plate 45 back through space 30, through legend plate 25 and then through a protective film, thus providing an enhanced viewable sign.

The light may be provided by the use of LED devices or Fiber Optic devices or any combination of said devices.

The power sources for the lighting devices may be mains electricity at mains voltage, or, voltage may be reduced to lower voltage by use of voltage reduction devices.

Power may also be supplied from solar cells and storage devices controlled by suitable charging and power control electronic devices.

Control devices may contain sensors and switching devices to read light conditions and control power to provide light or switch off light when not required.

1. A Solar or Electric powered multi-layered sign using LED Lamps and/or Fiber Optic Light sources to enhance readability powered by mains electricity of any voltage

2. A sign as in 1 powered by solar cells and a storage device.

3. Multi-layered signs comprising of Letters, numbers, graphics manufactured as described in 1.

4. Multi-layered signs comprising of Letters, numbers, graphics manufactured as described in 2

5. Multi-layered signs comprising of Letters, numbers, graphics manufactured as described in 1. with side angle point edge mounted light sources

6. Multi-layered signs comprising of Letters, numbers, graphics manufactured as described in 1. with direct point mounted light sources

7. Multi-layered signs comprising of Letters, numbers, graphics manufactured as described in 2. with side angle point edge mounted light sources.

8. Multi-layered signs comprising of Letters, numbers, graphics manufactured as described in 2. with direct point mounted light sources
